(19) United States
(12) Patent Application Publication
(10) Pub. No.: US 2005/0224590 A1
(43) Pub. Date: Oct. 13, 2005

(54) Method and system for fabricating integrated circuit chips with unique identification numbers

(76) Inventors: John Melngailis, Chevy Chase, MD (US); William R. Bandy, Gambrills, MD (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/104,517

(22) Filed: Apr. 13, 2005

Related U.S. Application Data
(60) Provisional application No. 60/561,598, filed on Apr. 13, 2004.

(51) Int. Cl. G06K 19/06

(52) U.S. Cl. 235/492

(57) ABSTRACT

A method, system, and apparatus for writing data to integrated circuits is described. A charged particle source supplies a beam of charged particles. A wafer plate mounts a wafer having a plurality of transistors distributed among an array of integrated circuits on a surface. A beam column receives the beam of charged particles and selectively passes the beam of charged particles to the surface of the wafer. The selectively passed beam of charged particles irradiates selected transistors of the plurality of transistors to cause the selected transistors to permanently change from a first state to a second state. The second state can be a fully “on” state, a fully “off” state, or a state in between for the selected transistors. Each integrated circuit of the array includes at least one of the selected transistors and at least one non-selected transistor. A combination of selected and non-selected transistors of the integrated circuit corresponds to data for the integrated circuit.

This application claims the benefit of U.S. provisional application Ser. No. 60/561,598, filed Apr. 13, 2004, which is incorporated herein by reference in its entirety.

### BACKGROUND OF THE INVENTION

1. Field of the Invention

The present invention relates to the fabrication of integrated circuit chips/dies with unique identification numbers and/or other unique data.

2. Background Art

Generally, in the manufacture of microelectronic chips, such as Pentium microprocessor chips, effort is expended to manufacture all of the chips to be alike. In other words, the circuitry of each chip in a lot is ideally manufactured to be identical. There are, however, applications where each chip needs to have a unique aspect, such as a unique electrically readable identification number, including applications such as cell phones, smart cards, or electronic tags—also referred to as radio frequency identification (RFID) tags.

In some situations, the chips can all be fabricated in an identical fashion, and then the unique identity can be programmed into the chip. For example, a unique identification number can be electrically programmed into a chip in a permanent or semi-permanent fashion after their fabrication. However, there are benefits to writing the unique identification numbers into chips during their fabrication. Particularly for high volume applications, such as RFID tags, this provides advantages such as low cost. For example, lower costs may be obtained if writing the unique identification number into chips does not add a significant number of steps to the fabrication process, and if the writing process is rapid. Furthermore, the unique identification number written into a chip during fabrication can be written permanently (i.e., it is not re-programmable, and generally the identity cannot be altered without destroying the chip).

The electrical programming of identification numbers into chips is a relatively simple process. However, electrically programmed chips can in some cases be de-programmed or re-programmed. While this may make a chip reusable with a new identity number, it also makes the chip vulnerable to unwanted tampering or accidental loss of identity.

Some chips are currently being programmed during fabrication by breaking existing electrical connections at on-chip sites, such as by breaking connections using laser pulses. For example, in such a process, for an 80-bit identification number, there are 80 possible connection sites to either cut or not cut. Each programmed chip can thus have connections in a different sequence to encode a unique identification number. However, such an implementation can cause space issues in a chip layout. Due to the area required by a laser focal spot, and a required area for spreading of the resulting heat, each programmed site has to occupy at least a relatively large area, such as a 10 μm wide space. Thus, the data written into a chip in this manner can end up taking a large amount of chip space.

Thus, what is needed is improved writing/programming techniques for chips that have unique data and/or other aspects. Furthermore, these techniques should allow for the creation of identifying data in chips that is permanent, consumes less space, and has lower processing cost than conventional processes.

### BRIEF SUMMARY OF THE INVENTION

Methods, systems, and apparatuses for writing data to integrated circuits are described. The data can be used to uniquely identify the integrated circuit, and/or for other purposes. Furthermore, the data can be permanent or semi-permanent. The resulting integrated circuits can be incorporated in all types of electronic devices, including cell phones, smart cards, and electronic tags.

Methods, systems, and apparatuses for disabling current flow through transistors using a charged particle beam are also described. These methods, systems, and apparatuses have many applications.

In an aspect of the present invention, data is written to an (IC) chip. A beam of charged particles is generated. The beam is directed at a transistor of the IC chip. Charged particles of the beam are implanted in the transistor to cause current flow through the transistor to be interrupted (or reduced) during operation of the transistor to cause the transistor to permanently enter an altered state.

In another aspect of the present invention, data is written to integrated circuits of a wafer. A beam of charged particles is generated. The beam is directed at a wafer having a surface comprising a plurality of transistors distributed among an array of integrated circuits. Charged particles of the beam are implanted in selected transistors of the plurality of transistors to cause the selected transistors to each permanently enter an altered, desired state. Each integrated circuit of the array includes at least one of the selected transistors and may include one or more non-selected transistors (i.e., it is possible that all of the transistors are either selected or non-selected). A combination of selected transistors and non-selected transistors (when present) for an integrated circuit corresponds to data for the integrated circuit.

In another aspect of the present invention, a system for writing data to integrated circuit (IC) chips of a wafer is described. A charged particle source supplies a beam of charged particles. A wafer plate mounts a wafer having a plurality of transistors distributed among an array of integrated circuits on a surface. A beam column receives the beam of charged particles and selectively passes the beam of charged particles to the surface of the wafer. The selectively passed beam of charged particles irradiates selected transistors of the plurality of transistors to cause the selected transistors to permanently enter an altered, desired state. Each integrated circuit of the array includes at least one of the selected transistors and may include one or more non-selected transistors (i.e., it is possible that all of the transistors are either selected or non-selected). The combination of selected transistors and non-selected transistors (when present) of the integrated circuit corresponds to data for the integrated circuit.

In aspects of the present invention, the beam is a single beam of charged particles. For example, the single beam can be produced by a single charged particle source, or by multiple charged particles source beams that are combined into a single beam. Alternatively, the beam can include multiple individual sub-beams of charged particles. For example, the multiple sub-beams can be independently produced, or can be produced by masking a single beam of charged particles.

In aspects of the present invention, transistors may be altered to be in one of any number of desired transistor states, depending on the particular application. Thus, in an example two transistor state embodiment, causing a transistor to enter an altered state causes the transistor to change from operation in an initial first state to operation in a second state. When there are more than two transistor states possible, causing a transistor to enter an altered state causes a transistor to change from operation in an initial first state to operation in one of the other possible states. Thus, a single transistor can represent a single bit of data (e.g., embodiments where transistors can be operating in one of two states), or can represent multiple bits of data (e.g., embodiments where transistors can be operating in one of a plurality of states). For example, when four states are possible, a single transistor can represent 2 bits of data.

These and other advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an example integrated circuit data writing system, according to an embodiment of the present invention.

FIG. 2 shows a cross-sectional view of an example MOSFET.

FIG. 3 illustrates example operation of an NMOS transistor.

FIG. 4 shows a beam of charged particles directed to a gate region of the MOSFET of FIG. 2 to implant the gate region with charged particles, according to an example embodiment of the present invention.

FIG. 5 shows a flowchart providing example steps for altering current flow through a transistor, according to an example embodiment of the present invention.

FIG. 6 shows a plan view of a MOSFET with implantation region, according to an example embodiment of the present invention.

FIG. 7 shows an example focused ion beam wafer writing system, according to an example embodiment of the present invention.

FIG. 8 shows a flowchart providing example steps for writing/programming integrated circuits of a wafer, according to an example embodiment of the present invention.

FIG. 9 shows a plan view of an example surface of a wafer, according to an example embodiment of the present invention.

FIG. 10 shows a plan view of an example integrated circuit, according to an example embodiment of the present invention.

FIG. 11 shows an example mask having a round aperture for generating a beam with round cross-section, according to an embodiment of the present invention.

FIG. 12 shows an example mask having a rectangular aperture for generating a beam with rectangular cross-section, according to an embodiment of the present invention.

FIG. 13 shows a portion of a multiple ion beam projection system, according to an example embodiment of the present invention.

FIG. 14 shows an example NMOS MOSFET where a region above the channel region has been thinned, according to an example embodiment of the present invention.

FIGS. 15 and 16 show plots of example saturation currents (y-axis) versus ion dose (x-axis) for example NMOS and PMOS transistor processing embodiments of the present invention, respectively.

FIG. 17 shows plots of example PMOS transistor threshold voltage shifts (y-axis) versus ion energy (x-axis), according to an example embodiment of the present invention.

FIG. 18 shows plots of example PMOS transistor drain current shifts (y-axis) versus ion energy (x-axis), according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

Embodiments of the present invention are described herein for writing data to integrated circuit (IC) chips/dies. Data can be written to the IC chips/dies, according to the embodiments of the present invention, to provide identifying data to the IC chips/dies, and/or other types of data or aspects. In embodiments, the written data may or may not be unique. Furthermore, the date may be permanent or semi-permanent (e.g., the later changeable by further altering chip data according to the embodiments described herein). These embodiments are provided for illustrative purposes, and are not limiting. Additional operational and structural embodiments for the present invention will be apparent to persons skilled in the relevant art(s) from the description herein. These additional embodiments are within the scope and spirit of the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

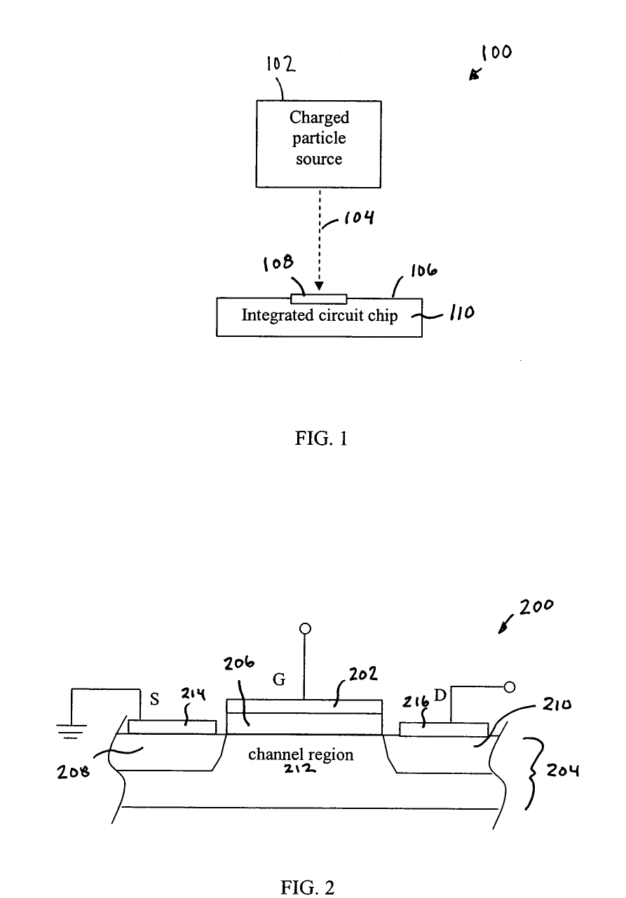

FIG. 1 shows an example integrated circuit data writing system 100, according to an embodiment of the present invention. As shown in FIG. 1, system 100 includes a charged particle source 102. Charged particle source 102 generates a beam 104 of charged particles. Beam 104 is received at a surface 106 of an integrated circuit (IC) chip 110. In particular, beam 104 is received at a transistor 108 of IC chip 110.

In the example of FIG. 1, transistor 108 conducts current in a first state (e.g., a data “0” or “1” state), and does not conduct current in a second state. In other words, when transistor 108 is “on” (e.g., conducting current), transistor 108 is considered to be in a first state. When transistor 108 is “off” (e.g., not conducting current), transistor 108 is considered to be in a second state. In an embodiment, transistor 108 is normally in one of the first and second states. For example, transistor 108 may be configured to be normally “on”, and thus always conducting current during operation. The “on” state represents a certain data value, either a “0” or “1”. According to the present invention, beam 104 of charged particle source 102 is used to cause transistor 108 to change states. For example, when beam 104 irradiates transistor 108, which is normally “on”, for example, transistor 108 is caused to change to a normally “off” state. Beam 104 causes transistor 108 to no longer conduct enough current to be considered “on”. In an embodiment, this state change is permanent. Thus, according to the present invention, transistor 108 can be placed in either state, to represent a single bit of data. Transistor 108 can either be left alone to remain in the first state (e.g., conducting), or can be irradiated by beam 104 to change to the second state (e.g., not conducting).

The embodiment just described relates to a two transistor state application of the present invention. In such an embodiment, a single transistor 108 can represent a single bit of data. In an alternative embodiment, transistor 108 can be placed in one or more states between fully “on” and “off” states. In other words, beam 104 can irradiate transistor 108 to alter current flow such that transistor 108 conducts an amount of current less than that considered to be fully “on”, but more than considered to be fully “off.” Thus, in such an embodiment, transistor 108 can represent more than a single bit of data. For example, if beam 104 is configured to place transistor 108 into any one of four states, such as one of fully “on”, fully “off”, and two additional states in between, transistor 108 has four possible states and can thus represent two bits of data. In embodiments, beam 104 can be configured to place a single transistor 108 in any number of states to represent any number of bits of data.

Furthermore, in a likewise fashion, selected transistors of a plurality of transistors 108 can be irradiated as described above to create a string of data bits, representing a multi-bit data value of any length, based on the states of the transistors. Such multi-bit data value can be used as an identification number for IC chip 110, which may be a unique identification number.

In an example embodiment, a plurality of transistors having two possible states can be combined to represent an identification number. For example, a combination of 50 transistors having two possible states can store approximately 10¹⁵ different identification numbers. In another example embodiment, a plurality of transistors having more than two possible states can be combined to represent an identification number. For example, a combination of 50 transistors with three possible states can store approximately 10²⁴ identification numbers. This is a significantly higher number of identification numbers as compared to a combination of transistors having two possible states. 32 transistors having three possible states can store approximately the same number of identification numbers as 50 transistors having two possible states.

For example, transistor 108 may be a transistor such as a field-effect transistor (FET), including a metal-oxide semiconductor FET (MOSFET). A FET is a three-terminal device in which the current between first and second terminals is controlled at a third terminal. For example, a voltage can be applied at the third terminal to control the current. In an embodiment, the first and second terminals may be interchangeably referred to as “source” and “drain” terminals, and the third terminal may be a “gate” terminal. In an embodiment, the three terminals are formed in or on a semiconductor material.

FIG. 2 shows a cross-sectional view of an example MOSFET 200. MOSFET 200 has a metal or semiconductor material gate contact 202 separated from a semiconductor material layer 204 by an insulator material 206 (e.g., an oxide layer). A source region 208 and a drain region 210 are formed in semiconductor material layer 204. These regions of semiconductor material layer 204 are typically doped differently from the base semiconductor material layer 204. For example, source region 208 and drain region 210 may be “n” doped, while the base semiconductor material layer 204 is “p” doped (i.e., an “n-channel” or NMOS device). Alternatively, source region 208 and drain region 210 may be “p” doped, while the base semiconductor material layer 204 is “n” doped (i.e., a “p-channel” or PMOS device). The present invention is applicable to any doping schemes and configurations for MOSFET 200. A channel region 212 is present in MOSFET 200 between source region 208 and drain region 210. A source contact 214 is formed on source region 208 and a drain contact 216 is formed on drain region 210.

Note semiconductor material layer 204 can be any semiconductor material, including silicon (Si) or Gallium Arsenide (GaAs).

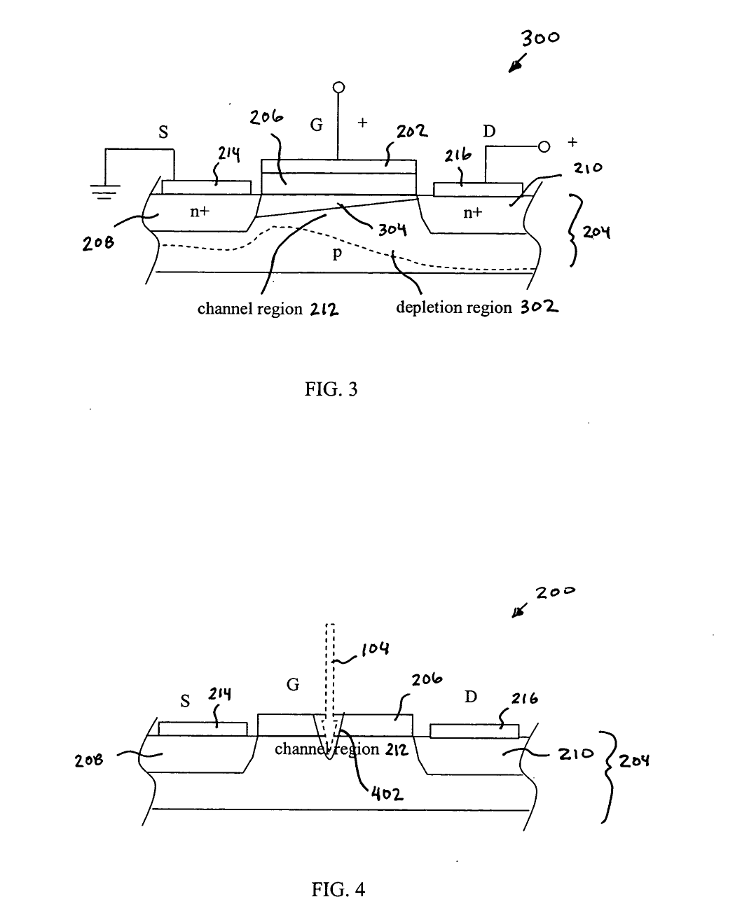

FIG. 3 illustrates example operation of a transistor 300 that is an NMOS version of MOSFET 200. During normal operation, a voltage is applied at gate contact 202 that forms a depletion region 302 in semiconductor material layer 204. Furthermore, the voltage applied at gate contact 202 forms a thin surface region containing mobile carriers, called a channel 304, in channel region 212 of semiconductor material layer 204. An n-channel device (such as shown in FIG. 3) has electrons for the majority carrier, while a p-channel device has holes for the majority carrier. Formation of channel 304 allows current to flow between source region 208 and drain region 210.

As described above, a transistor that is biased to be normally conducting current (e.g., through channel region 304 for NMOS transistor 300) can represent data of a first state. Other current conductivity levels for a transistor can alternatively represent the first state. Furthermore, a transistor that is altered or changed to be conducting current differently from the first state can represent data of a second state. For example, a transistor altered to be not conducting current can represent data of a second state. Alternatively, if the transistor is altered or changed to conduct current between fully-conducting and non-conducting states, the transistor can represent the second state (or a third state, a fourth state, etc.). According to the present invention, a beam of charged particles is used to cause a transistor to make a change from the first state to a second state. As shown in FIG. 4, for example, beam 104 is directed to a gate region of MOSFET 200 to implant charged particles in a region 402. The charged particles in region 402 of beam 104 disrupt channel region 212 so that a conducting channel 304 can no longer form in MOSFET 200 (e.g., fully off), or can only form in a limited fashion. Thus, MOSFET 200 no longer conduct sufficient current to be considered in the first state, and is transferred to the second state.

Thus, the charged particles of beam 104 can be used to cause a disruption to channel region 212 to limit or prevent current flow, causing MOSFET 200 to remain permanently in a less conductive or fully off state. Alternatively, by irradiating the gate region of MOSFET 200, beam 104 can be used to affect the threshold voltage of MOSFET 200 to cause MOSFET 200 to shut off (or partially shut off). For example, insulating layer 206, which may be an oxide, is sensitive to defects such as charged traps, which may be caused by charged particles such as ions. If a sufficient charge trap density is caused in insulating layer 206 (e.g., 5×10¹²/cm²), this can cause a shift in the threshold voltage. The threshold voltage determines the requirements for turning a MOSFET on or off. If the threshold voltage can be increased to a level that cannot be overcome, this will cause MOSFET 200 to partially or completely turn off. Thus, beam 104 can be used to cause defects in insulating layer 206 to raise the threshold voltage of MOSFET 200, to turn it permanently partially or fully off, to represent a data state.

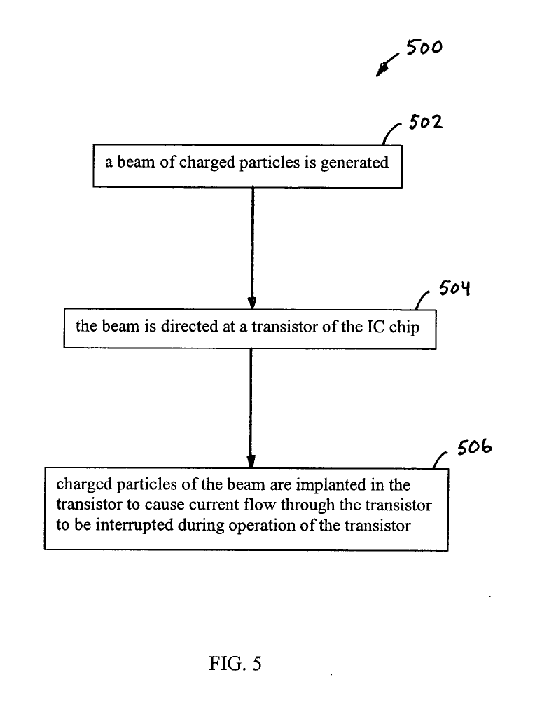

FIG. 5 shows a flowchart 500 providing example steps for altering current flow through a transistor, according to an example embodiment of the present invention. Other structural and operational embodiments will be apparent to persons skilled in the relevant art(s) based on the following discussion. The steps of FIG. 5 are described in detail below.

Flowchart 500 begins with step 502. In step 502, a beam of charged particles is generated. For example, the beam is beam 104, generated by charged particle source 102, shown in FIG. 1. The present invention is applicable to any type of charged particle, including positively charged particles and negatively charged particles. For example, electrons or ions may be used. Thus, the present invention may incorporate any type of charged particle source, including electron beam sources and ion beam sources. An example machine for supplying ions is the Nanofab 150, manufactured by Finkelstein Associates Inc. (FAI), which can be programmed to deliver a precise dose of ions to specific areas with a lateral resolution of better than 100 nm over an entire wafer. The ion dose can be easily controlled in the range of 10¹¹ to 10¹³ ions/cm².

In step 504, the beam is directed at a transistor of the IC chip. For example, the transistor is transistor 108 of IC chip 106. IC chip 106 may be a separate chip/die, or may be part of a semiconductor wafer. The present invention is applicable to any type of transistor, including BJTs, JFETs, MOSFETs, etc. The transistors may be depletion mode (normally on) or enhancement mode (normally off) types.

In step 506, charged particles of the beam are implanted in the transistor to cause current flow through the transistor to be interrupted during operation of the transistor. For example, the charged particles can be implanted in the channel region of the transistor, such as in channel region 212 of MOSFET 200, as shown in FIG. 4, and/or in insulating layer 206. In embodiments, current flow through the transistor can be altered to be completed interrupted, or merely reduced.

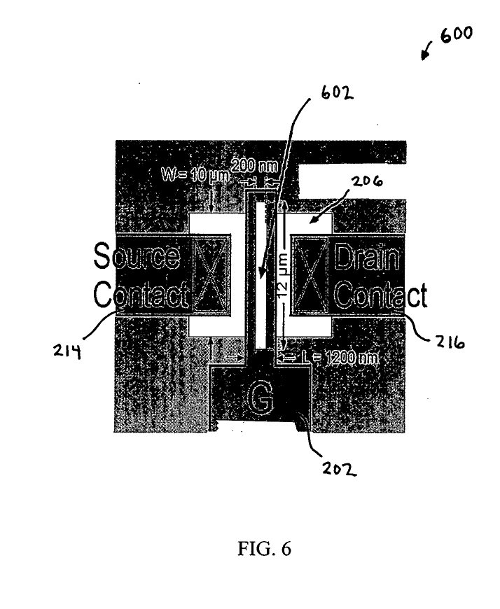

FIG. 6 shows a plan view of a MOSFET 600, which is generally similar to MOSFET 200 of FIGS. 2 and 4, according to an example embodiment of the present invention. MOSFET 600 has example dimensions of 1200 nm wide and greater than 12 μm long for a rectangular polysilicon gate portion extending over insulating layer 206. Insulating layer 206, which may be an oxide layer, is roughly 10 μm by 10 μm in size. An implantation channel 602 is shown formed in the rectangular portion of gate contact 202 that extends over insulating layer 206, where a charged particle beam is directed to implant charged particles. As shown in FIG. 6, implantation channel 602 extends across a region between source contact 214 and drain contact 216, to extend across the width of the channel region under insulating layer 206. In this manner, charged particles (e.g., electrons or ions) are implanted in a manner to adjust (e.g., reduce or prevent) current flow through the channel region between source contact 214 and drain contact 216 (and/or to shift the threshold voltage of MOSFET 600).

In embodiments, implantation channel 602 can be formed across the entire width of the channel region, to completely prevent current flow to create a desired state. Alternatively, implantation channel 602 can be formed across a portion of the width of the channel region, to reduce current flow to create a desired state. In embodiments, all of, or any portion of the gate region and/or channel region, can be irradiated to reduce or prevent current flow, to create a desired state. For example, if a 6 μm length of a 12 μm long implantation channel 602 is irradiated (i.e., half of the length), the current carrying capacity of the MOSFET 600 will be reduced by approximately one half. Thus, selection of an area size to be implanted can be used to create a desired state.

In the example of FIG. 6, implantation channel 602 is 200 nm wide and 12 μm long, but can have other sizes as necessary for the particular application. Thus, a charged particle beam, such as a focused ion beam (FIB), having a beam width of 200 nm could implant ions throughout implantation channel 602 in a single length-wise pass of implantation channel 602. Alternatively, a beam having a narrower width (e.g., 100 nm or less) could make multiple length-wise (or width-wise) passes of implantation channel 602 to implant ions throughout implantation channel 602. For example, the beam could be controlled to make a zig-zag, or continuous “S” shaped pattern (i.e., a “serpentine” pattern), or any other applicable pattern, to “paint in” all of the area of implantation channel 602.

A wide range of ion energies and ion doses may be used, and a wide range of gate thicknesses may be processed, in embodiments of the present invention. For example, a MOSFET transistor having a 200 nm thick polysilicon gate contact can be used. The polysilicon gate is fabricated to remain uncovered for irradiation, and can be subsequently covered (e.g., with a passivation/oxide layer), if desired. Given the known sensitivity of a gate oxide (insulating layer 206) to charged traps, a low dose of ions, such as in the range of 10¹² to 10¹³/cm², is enough to alter the threshold voltage and thus turn off the transistor. Such a low dose amount is three to four orders of magnitude lower than a dose required to mill off any useful thickness of conductor material.

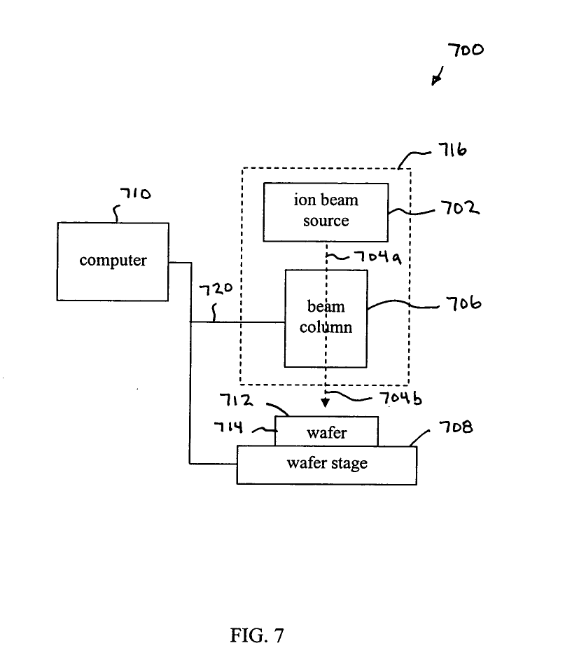

FIG. 7 shows an example focused ion beam wafer writing system 700, according to an example embodiment of the present invention. As shown in FIG. 7, system 700 includes an ion beam source 702, a beam column 706, a wafer stage 708, and a computer 710. In an embodiment, ion beam source 702 and beam column 706 are present together in an ion beam system 716. For example, ion beam system 716 may enclose ion beam source 702 and beam column 706 together in a vacuum chamber.

As shown in FIG. 7, ion beam source 702 generates charged particles, which radiate from ion beam source 702 as ion beam 704a.

Ion beam 704a passes into beam column 702, where it is one or more of focused, accelerated, deflected, and interrupted as needed, and exits as ion beam 704b to a surface 712 of a wafer 714 mounted on wafer stage 708.

Wafer stage 708 mounts wafer 714 in well known manner. Surface 712 of wafer 714 has a plurality of transistors distributed among an array of integrated circuits formed on wafer 714. Beam 704b irradiates selected transistors of the plurality of transistors formed on surface 712 to cause the selected transistors to permanently transition from a first state to a second state (e.g., states that are permanently “on” or “off” conductive states, which can be also referred to data states—e.g., “1” and “0”—and/or states in between “on” or “off”). For example, as described above, beam 704b can cause a transistor to permanently transition from a normally conductive state to a non-conductive state.

Computer 710 is coupled to beam column 706 and wafer stage 708, and may be optionally coupled (not shown in FIG. 7) to ion beam source 702. As further described below, computer 710 is used to control operation of beam column 706, the position of wafer 712, and/or operation of ion beam source 702.

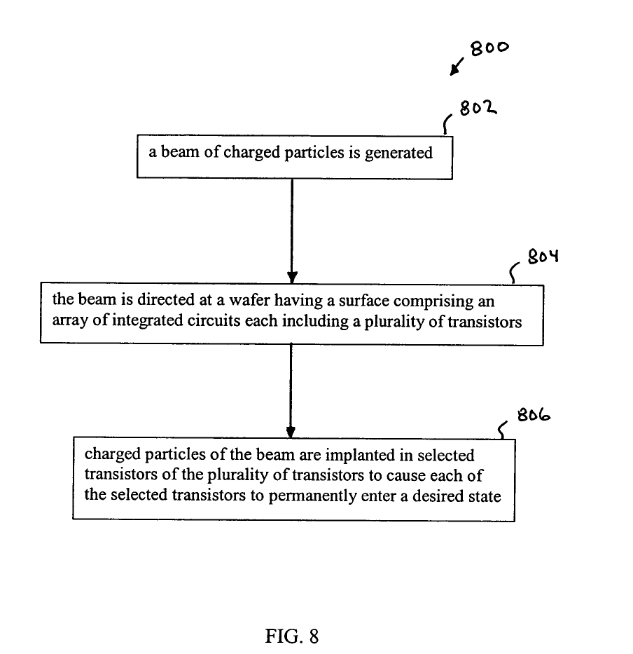

FIG. 8 shows a flowchart 800 providing example steps for writing/programming integrated circuits of a wafer, according to an example embodiment of the present invention. For example, system 700 shown in FIG. 7 may be used to perform the process of flowchart 800. Other structural and operational embodiments will be apparent to persons skilled in the relevant art(s) based on the following discussion. The steps of FIG. 8 are described in detail below.

Flowchart 800 begins with step 802. In step 802, a beam of charged particles is generated. For example, the beam can be ion beam 704a generated by ion beam source 702, as shown in FIG. 7. In an embodiment, computer 710 may generate one or more control signals to turn on/shut off ion beam source 702, and/or to control ion energies, ion doses, etc., generated by ion beam source 702.

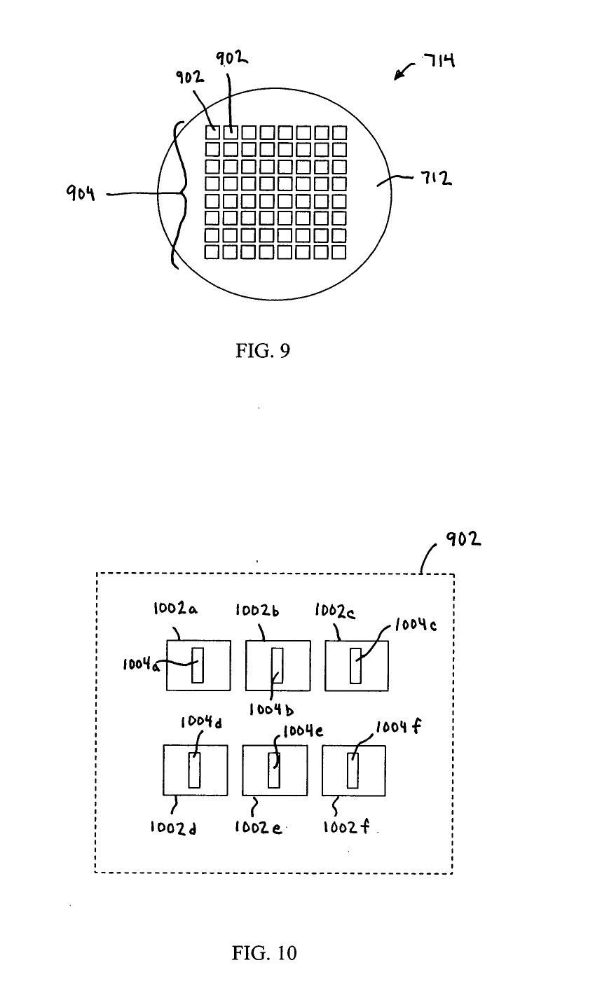

In step 804, the beam is directed at a wafer having a surface comprising an array of integrated circuits each including a plurality of transistors. For example, the beam is directed at surface 712 of wafer 714 shown in FIG. 7. FIG. 9 shows a plan view of an example surface 712 of wafer 714, according to an example embodiment of the present invention. As shown in FIG. 9, surface 712 includes a plurality of integrated circuits 902, arranged in an array 904. Integrated circuits 902 may be subsequently separated from wafer 714 to create individual integrated circuit chips, in any conventional manner. The invention is applicable to any size of integrated circuits 902, and any number of integrated circuits 902 in array 904.

FIG. 10 shows a plan view of an example integrated circuit 902, according to an example embodiment of the present invention. As shown in FIG. 10, integrated circuit 902 includes first through sixth transistors 1002a-f. In embodiments, an integrated circuit 902 can include any number of one or more transistors 1002, and any size for transistors 1002 (transistors 1002 are shown as large with respect to integrated circuit 902 in FIG. 10, for illustrative purposes).

In step 806, charged particles of the beam are implanted in selected transistors of the plurality of transistors to cause each of the selected transistors to permanently enter a desired state. For example, as described above, charged particles of a beam may be implanted in a gate and/or channel region (or any part of a gate and/or channel region) of transistors to permanently interrupt current flow through a transistor, turning the transistor permanently off, or to merely alter current flow through the transistor, turning the transistor partially off. FIG. 10 shows an implantation channel 1004a-f for each of transistors 1002a-f, similar to implantation channel 602 described above with respect to FIG. 6. For example, implanting ions of beam 704b in selected ones of implantation channels 1004a-f causes the respective transistors 1002a-f to permanently enter a non-current conducting state (e.g., an “off” state), which can be interpreted as a “0” or “1” data value for the particular one of transistors 1002a-f. Alternatively or additionally, selected ones of transistors 1002a-f can be caused by beam 704b to permanently enter a state between fully “on” or “off.” Transistors 1002a-f can each be caused to enter the same desired state, or can each be caused to enter a desired state different from one or more of the others of transistors 1002a-f.

By causing selected transistors of an integrated circuit to permanently change from a first data state to a second data state, a combination of transistors of the first state (i.e., non-selected transistors) with transistors of the second state (selected transistors) can be used to create an identity value for the integrated circuit. For example, the combination of transistors can be used to represent data values of a data string, such as an identification number for the integrated circuit.

In embodiments, computer 710 may control operation of beam column 706 and the position of wafer 714 in any conventional manner, such as used in conventional focused ion beam (FIB) and lithography (e.g., photolithography) systems. For example, in an embodiment, computer 710 receives position information regarding wafer 712. A position sensor may be present that detects a position of wafer 712 and generates the position information. Any type of position sensor may be used, including those used in conventional FIB and lithography processes, such as a laser interferometer, etc. One or more position sensors may be incorporated with wafer stage 708 to generate the position information.

In an embodiment, computer 710 uses the position information for wafer 712 to control a position of wafer 712. For example, computer 710 may provide a position control signal to wafer stage 708 to control a position of wafer 714, using conventional means. Thus, computer 710 may control a position of wafer 714 so that all integrated circuits 902 of wafer 714 are positioned in a path of beam 704b to be processed. Thus, wafer 714 may be moved by a motor of wafer stage 708 in a zig-zap or continuous “S” shaped pattern (or other pattern) so that all integrated circuits are processed. Moreover, the scanning can be done without stopping the wafer, also referred to as “write-on-the-fly.” Furthermore, the position information may be used to control a position of wafer 714 and/or a direction of beam 704b to precisely irradiate the areas of transistors 1002 shown in FIG. 10 that are desired to be irradiated, such as implantation areas 1004.

For example, as shown in FIG. 7, computer 710 may generate a control signal 720 to beam column 706 that aims or controls a direction of beam 704b to irradiate the desired areas of wafer 714. Furthermore, in embodiments, computer 710 may control focusing of beam 704b and/or a blanking of beam 704b. For example, computer 710 may control the blanking (i.e., temporarily shutting off or blocking) of beam 704b by beam column 706, or by ion beam source 702, so that beam 704b can be repositioned to a next desired target area of wafer 714 to be irradiated, without irradiating undesired areas in between.

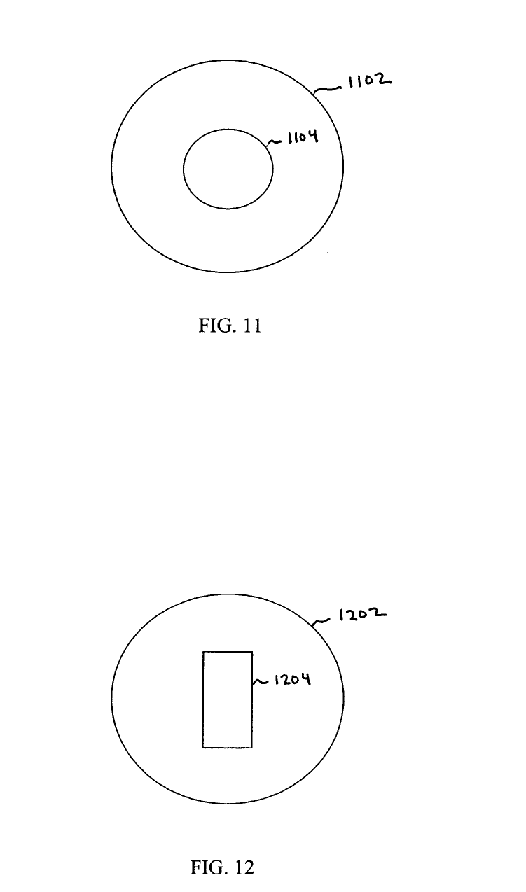

Note that any shape of beam cross-section may be created by ion beam source 702 and/or beam column 706, including a minimum diameter beam “spot” that is scanned over any desired area. FIG. 11 shows an example mask 1102 having a round aperture 1104 for generating a round beam cross-section, according to an embodiment of the present invention. FIG. 12 shows an example mask 1202 having a rectangular aperture 1204 for generating a rectangular beam cross-section. For example, a rectangular aperture 1204 can be used to implant an implantation channel, such as an implantation channel 1004 of FIG. 10, in a single burst, without having to scan the length, etc. of the implantation channel with the beam. Masks 1102 and 1202 may be present in beam source 702 (e.g., the output nozzle) and/or in beam column 706, to filter beam 704a to create beam 704b of a desired shape. The present invention is applicable to generating other shapes for beam cross section, as would be understood by persons skilled in the relevant art(s) according to the teachings herein, and as would be dictated by the particular application.

In further embodiments of the present invention, multiple charged particle beams are used. For example, the multiple charged particle beams may be generated by multiple beam sources, or by a single beam source that is filtered by a mask. For example, the mask may have multiple apertures or holes therethrough to convert a single beam that is passing through into multiple beams or sub-beams. In an embodiment, each aperture can be individually opened and closed (under computer control, for example), to control “blanking” of the sub-beams so that desired areas of a wafer are irradiated, while locations between the desired areas are not irradiated by the sub-beams that are moving therebetween. The mask may be located in ion beam source 702 or beam column 706, for example.

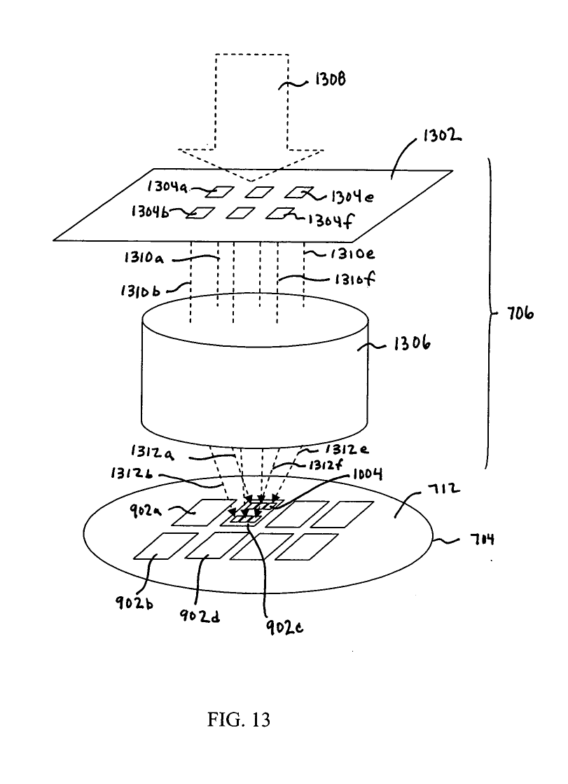

For example, FIG. 13 shows a portion of a multiple ion beam projection system 1300, according to an example embodiment of the present invention. System 1300 includes a mask 1302 and ion optics 1306. In an embodiment, mask 1302 and ion optics 1306 are included in a beam column 706 (e.g., also referred to as an “ion column” in an ion charged particle embodiment). Mask 1302 receives an ion beam 1308, which may be a broad or wide beam of ions. Mask 1302 includes apertures 1304a-1304f. In the example of FIG. 13, apertures 1304 are rectangular openings, although they may have other shapes. Furthermore, any number of apertures 1304 may be present, depending on the arrangement of target areas and/or number of target areas to be simultaneously irradiated.

Apertures 1304a-1304f create respective sub-beams 1310a-1310f from ion beam 1308. In an embodiment, apertures 1304a-1304f are permanently open in mask 1302. In another embodiment, one or more of apertures 1304a-1304f can be independently opened and closed, to control creation of one or more of sub-beams 1310a-1310f (e.g., under the control of computer 710). Thus, in such an embodiment, mask 1302 can be referred to as a programmable mask. In such an embodiment, mask 1302 can include any type of actuation mechanism for opening and closing apertures 1304, including electromagnetic, a MEMS-type device including electromechanical shutters, and other actuation devices. For example, a programmable aperture array may be used as described in I. L. Berry, et al., “Programmable Aperture Plate for Maskless High-throughput Nanolithography” J. Vac. Sci. Technol. B15 2382 (1997), which is incorporated herein by reference in its entirety.

Optics 1306 are optionally present to focus or de-magnify sub-beams 1310a-1310f to a smaller region than would be otherwise covered by sub-beams 1310a-1310f. Optics 1306 can include any ion optics components, as would be known to persons skilled in the relevant art(s). Optics 1306 outputs de-magnified sub-beams 1312a-1312f.

In effect, an image created by apertures 1304 of mask 1302 is projected on surface 712 of wafer 714, as de-magnified by optics 1306. For example, as shown in FIG. 13, apertures 1304a-1304f (and optics 1306, when present) cause multiple sub-beams 1312a-1312f to simultaneously irradiate multiple rectangular implantation areas 1004 on an integrated circuit 902c.

An advantage of the creation of sub-beams is a faster irradiation process than a single beam. Multiple sub-beams can cover multiple areas of a wafer in parallel. Furthermore, “write-on-the-fly” schemes, such as described in I. L. Berry, et al. “Programmable Aperture Plate for Maskless High-throughput Nanolithography” J. Vac. Sci. Technol. B15 2382 (1997), can be used.

Similar processes to those described above can be used in an electron beam embodiment. For example, an electron beam can be used to directly affect transistors, or to expose resist over the wafer to protect some areas while leaving others exposed. This would be followed by blanket implantation by electrons or ions. In another embodiment, light beams could be used to expose the resist. Current techniques related to programming of RFID chips use a laser beam to form or not form connections on the RFID chip. Such an operation requires a very intense beam and relatively large chip area. In contrast, resist exposure followed by blanket implantation can use multiple beams, much lower light intensity, and much less chip area.

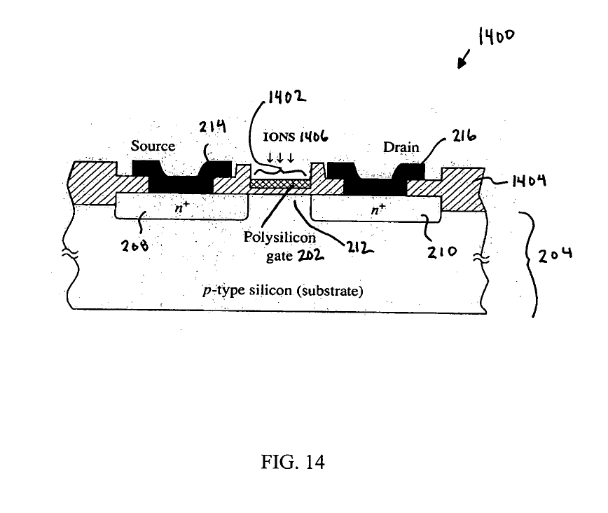

The region above the transistor channel may be thinned, such as to a thickness of 100 to 200 nm, to use reasonable ion energies. For example, FIG. 14 shows an example NMOS MOSFET 1400 where a region 1402 above channel region 212 has been thinned to remove a passivation, insulating material (e.g., oxide) (which is shown otherwise present in MOSFET 1400 as insulating layer 1404), and potentially an upper portion of gate 202. After irradiating channel region 212 of MOSFET 1400 with ions 1406, a passivation/insulating layer may be reformed over region 1402, if desired.

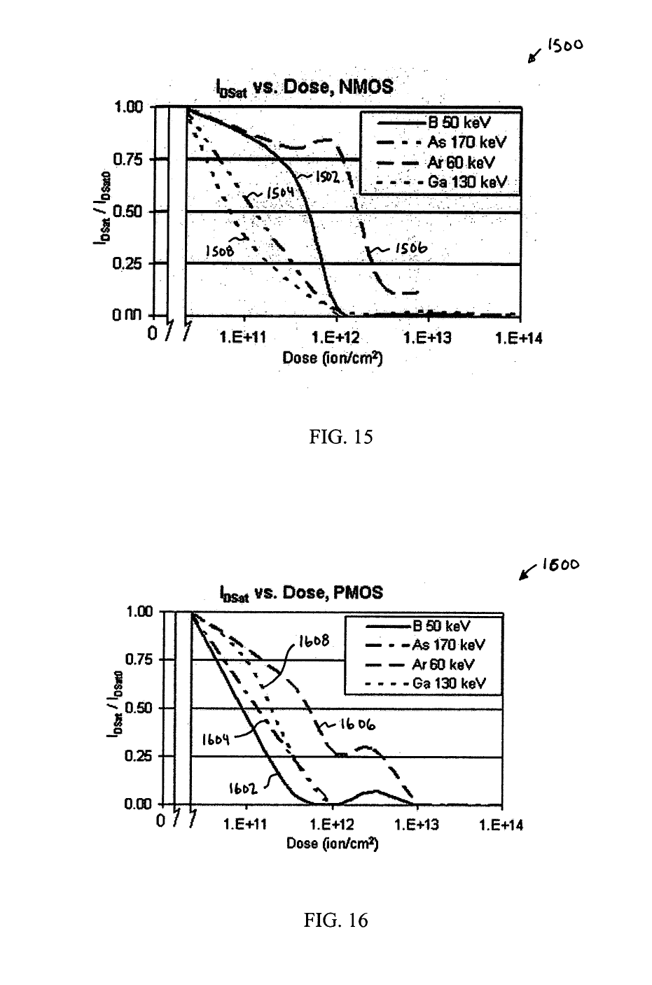

In example embodiments, transistors such as MOSFET 1400 were implanted with a series of ion doses and energies using both focused ion beam and broad beam implantation. FIGS. 15 and 16 show plots of example saturation currents (y-axis) versus ion dose (x-axis), for example NMOS and PMOS transistor processing embodiments of the present invention, respectively. In FIG. 15, plot 1502 relates to Boron ions, plot 1504 relates to Arsenic ions, plot 1506 relates to Argon ions, and plot 1508 relates to Gallium ions. In FIG. 16, the various plots are similarly labeled.

For FIGS. 15 and 16, relatively large transistors were used (the gates were 5 μm long and 15 μm wide) to provide ease in thinning region 1402. However, the invention is also applicable to smaller sized transistors. As indicated in FIGS. 15 and 16, a required ion dose to turn irradiated transistors off is seen to be of approximately 10¹²/cm², as long as the ions have sufficient energy to alter the gate oxide and/or the channel.

As shown in FIG. 15, for example, the normalized drain saturation current in an “on” state is roughly in the range of 0.8-1.0, while the same current in an “off” state is roughly in the range of 0.0-0.1, for plots 1502-1508. Thus, in an example two-transistor state embodiment, first and second states for a transistor can be represented by these “on” and “off” states. Alternatively, or in embodiments having more than two transistor states, one or more states can be present between the “on” and “off” states shown in FIG. 15. For example, in a four-state embodiment, a third state can be present at a drain saturation current of 0.35, and a fourth state can be present at a drain saturation current of 0.65, in addition to the first and second “on” and “off” states. Thus, a charged particle beam, such as beam 104, can be used to irradiate a transistor to conduct (or not conduct) current in one of the first through fourth states, to create a 2-data bit transistor. Any number of states can be created, according to embodiments of the present invention, as desired for the particular application.

The irradiation dose delivered to a given transistor can be controlled (e.g., reduced) so that the current carrying capability of the transistor is decreased but not reduced to zero. Thus, desired states between fully “on” and fully “off” can be created by controlling the ion dose. As shown in FIGS. 15 and 16, for example, a dose of 10¹¹ ions/cm² for some ion species (e.g., Arsenic and Gallium in FIG. 15) reduces the saturation current by about one half. The controllability/reproducibly of an implantation process is a factor in determining how many states can be thereby created.

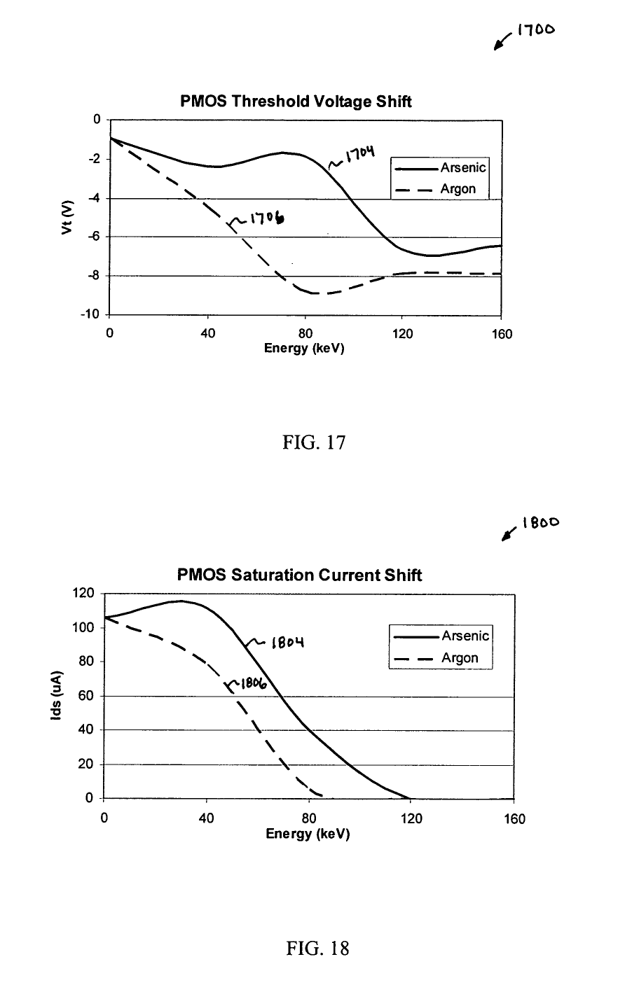

FIG. 17 shows plots of example PMOS transistor threshold voltage shifts (y-axis) versus ion energy α-axis). For FIGS. 17 and 18, gate 202 shown in FIG. 14 was thinned to 100 nm, and has a length of 5 μm and a width of 15 μm. The ion dose was 10¹² ions/cm². As shown in FIG. 17, in a PMOS transistor embodiment, there is a relatively strong shift in threshold voltage with an increase in ion energy. FIG. 18 shows plots of example PMOS transistor drain current shifts (y-axis) versus ion energy (x-axis). As shown in FIG. 18, there is a decrease in drain current with ion energy. In NMOS the threshold voltage appears to shift relatively less, while there is still a decrease in drain current, with an increase in ion energy.

Example Advantages of Various Embodiments of the Present Invention

The present invention is applicable to many charged particle sources, including electron beam sources and ion beam sources. In ion embodiments, a variety of ion types can be used. For example, the invention is applicable to Boron (B), Arsenic (As), Argon (Ar), and Gallium (GA) ions, to provide a few examples. Furthermore a low ion dose (˜10¹²/cm²) is sufficient.

In embodiments, the charged particle source may be an ion source. In such an embodiment, focused ion beam irradiation can be used to turn off a normally-on transistor. Such an approach has an advantage of requiring very minimal chip area, since focused ion beams can have very narrow beam widths. Thus, embodiments of the present invention are applicable to very small transistors, allowing for writable/programmable IC chips/dies having very small sizes.

A further advantage of the present invention is that the writable/programmable transistors, such as MOSFET transistors, can be fabricated according to standard fabrication (e.g., CMOS) processes.

In embodiments, a robust FIB system can be used to implant the IC chips, including those fabricated for RFID tags. Moreover, neither high resolution nor high placement accuracy are needed. A given transistor need only be implanted without implanting its neighbors. Assuming a 200 mm wafer with 80,000 chips, 120 transistors per chip, a 21 m² gate area, and a 100 pA beam current, results in an example implant time of approximately 5.6 min/wafer. Using a “write-on-the-fly” scheme, the wafer may be scanned at 12 cm/sec. Because a short amount of time (e.g., 33 μsec) is needed to implant each transistor, beam deflection and blanking times are not significant limitations.

Such an arrangement provides for much shorter wafer processing times than other techniques, such as using ion beam milling to write data (e.g., by using an ion beam to physically cut connectors). Ion beam milling can be slow: typically to remove 1 μm³ of metal requires 0.1 sec to 1 sec. Thus, even if each cut took only 0.01 seconds, an entire wafer with 1.6×10⁶ sites to cut would take over 4 hours in actual milling time.

An example type of electronic device that may be written/programmed according to embodiments of the present invention is an RFID “tag.” An RFID tag may be affixed to an item whose presence is to be detected and/or monitored. The presence of an RFID tag, and therefore the presence of the item to which the tag is affixed, may be checked and monitored by devices known as “readers.” Tags typically include one or more IC chips, such as a silicon chip less than 1 mm² that is attached to an antenna on substrate. It is typically desired that a tag have a unique identity, referred to as an identification number. Embodiments of the present invention can be used to write the identification number to the relatively small integrated circuit chips of tags at low cost.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. An system for writing data to integrated circuit (IC) chips of a wafer, comprising:
a charged particle source that supplies a beam of charged particles;
a beam column; and
a wafer plate that mounts a wafer having an array of integrated circuits each including a plurality of transistors;
wherein the beam column receives the beam of charged particles and selectively passes the beam of charged particles to the surface of the wafer;
wherein the selectively passed beam of charged particles irradiates selected transistors of said plurality of transistors to cause said selected transistors to each permanently enter a desired state,
wherein said plurality of transistors for each integrated circuit of said array includes at least one of said selected transistors, wherein a combination of states of said plurality of transistors of an integrated circuit corresponds to data for said integrated circuit.

2. The system of claim 1, wherein said beam of charged particles irradiates a channel region of said selected transistors to alter current flow capability through said channel region.

3. The system of claim 1, wherein said charged particles are electrons.

4. The system of claim 1, wherein said charged particles are ions.

5. The system of claim 4, wherein said beam of ions implants ions in a channel region of said selected transistors to alter current flow capability through said channel region.

6. The system of claim 4, wherein said beam column focuses said beam of ions at the surface of the wafer.

7. The system of claim 4, wherein said beam of ions passes through a single aperture.

8. The system of claim 7, wherein at a particular time, said beam column aims said beam at a particular transistor of said selected transistors.

9. The system of claim 7, wherein said aperture is rounded.

10. The system of claim 7, wherein said aperture is rectangular.

11. The system of claim 4, further comprising a mask having a plurality of apertures, wherein said beam of ions passes through said plurality of apertures to create a plurality of separate sub-beams of ions that irradiate the selected transistors.

12. The system of claim 11, wherein at a particular time, said beam column positions said beam of ions such that said plurality of separate sub-beams of ions irradiate a plurality of transistors of said selected transistors.

13. The system of claim 4, wherein said beam column selectively passes said beam and blanks said beam.

14. The system of claim 4, further comprising a computer system that receives position information regarding the wafer.

15. The system of claim 14, further comprising a position sensor that detects a position of said wafer and generates said position information.

16. The system of claim 15, wherein said position sensor is a laser interferometer.

17. The system of claim 14, wherein said computer system provides a position control signal to said wafer stage to control a position of said wafer.

18. The system of claim 17, wherein said wafer stage moves said wafer in a serpentine fashion so that all selected transistors on the surface of the wafer are moved through a target area of said beam.

19. The system of claim 14, wherein said computer system provides a control signal to said beam column to cause said beam column to selectively pass or blank said beam.

20. The system of claim 1, wherein the desired state for a particular selected transistor is an on state.

21. The system of claim 1, wherein the desired state for a particular selected transistor is an off state.

22. The system of claim 1, wherein the desired state for a particular selected transistor is a state between an on state and an off state.

23. A method for writing data to an (IC) chip having a plurality of transistors, comprising:
generating a beam of charged particles; and
directing the beam at a transistor of the IC chip, comprising the step of implanting charged particles of the beam in the transistor to cause current flow through the transistor during operation of the transistor to be altered to cause the transistor to permanently enter a desired state.

24. The method of claim 23, wherein said implanting step comprises:
implanting charged particles of the beam in a channel region of the transistor to cause current flow through the channel region of the transistor to be altered during operation of the transistor.

25. The method of claim 23, wherein the charged particles are electrons, wherein said generating step comprises generating a beam of electrons.

26. The method of claim 23, wherein the charged particles are ions, wherein said generating step comprises generating a beam of ions.

27. The method of claim 26, wherein said implanting step comprises implanting ions in a channel region of the transistor to alter current flow capability through the channel region.

28. The method of claim 23, further comprising:
focusing the beam at the surface of the wafer.

29. The method of claim 26, further comprising:
passing the beam of ions through a single aperture.

30. The method of claim 26, further comprising:
passing the beam of ions through a mask having a plurality of apertures to create a plurality of separate sub-beams of ions.

31. The method of claim 30, wherein said directing step comprises positioning the beam of ions such that the plurality of separate sub-beams of ions simultaneously irradiate a plurality of transistors of the IC chip.

32. The method of claim 26, further comprising:
selectively blanking the beam.

33. The method of claim 26, wherein a combination of the transistor and at least one further transistor of the IC chip corresponds to a data string for the IC chip.

34. A method for writing data to integrated circuits of a wafer, comprising:
generating a beam of charged particles; and
directing the beam at a wafer having a surface comprising an array of integrated circuits each having a plurality of transistors, comprising the step of implanting charged particles of the beam in selected transistors of the plurality of transistors to cause the selected transistors to each permanently enter a desired state;
wherein the plurality of transistors of each integrated circuit of the array includes at least one of the selected transistors, wherein a combination of states of the plurality of transistors of an integrated circuit corresponds to data for the integrated circuit.

35. The method of claim 34, wherein said implanting step comprises:
implanting charged particles of the beam in a channel region of the selected transistors to cause current flow through the channel region of the selected transistors to be altered during operation of the selected transistors.

36. The method of claim 34, wherein the charged particles are electrons, wherein said generating step comprises generating a beam of electrons.

37. The method of claim 34, wherein the charged particles are ions, wherein said generating step comprises generating a beam of ions.

38. The method of claim 37, wherein said implanting step comprises implanting ions in a channel region of the selected transistors to alter current flow capability through the channel region.

39. The method of claim 34, further comprising:
focusing the beam at the surface of the wafer.

40. The method of claim 37, further comprising:
passing the beam of ions through a single aperture.

41. The method of claim 37, further comprising:
passing the beam of ions through a mask having a plurality of apertures to create a plurality of separate sub-beams of ions.

42. The method of claim 41, wherein said directing step comprises positioning the beam of ions such that the plurality of separate sub-beams of ions simultaneously implant a plurality of the selected transistors during said implanting step.

43. The method of claim 34, further comprising:
selectively blanking the beam.

44. The method of claim 34, further comprising:
receiving position information regarding the wafer.

45. The method of claim 44, further comprising:
detecting a position of the wafer; and
generating the position information.

46. The method of claim 45, further comprising:
providing a position control signal to the wafer stage to control a position of the wafer based on the position information.

47. The method of claim 46, further comprising:
moving the wafer in a serpentine fashion so that all selected transistors on the surface of the wafer are moved through a target area of the beam.
